(19) United States
(12) Patent Application Publication
(10) Pub. No.: US 2023/0331022 A1
(43) Pub. Date: Oct. 19, 2023

(54) POLYMER SUBSTRATE FOR PRODUCING POLYMER VALUE PAPERS OR POLYMER SECURITY PAPERS

(71) Applicant: Hueck Folien Gesellschaft M.B.H., Baumgartenberg (AT)

(72) Inventors: Martin Egginger, Linz (AT); Anita Fuchsbauer, Linz (AT)

(73) Assignee: Hueck Folien Gesellschaft M.B.H., Baumgartenberg (AT)

(21) Appl. No.: 18/028,964

(22) PCT Filed: Sep. 28, 2021
(86) PCT No.: PCT/EP2021/076680

§ 371 Date: Mar. 28, 2023

(30) Foreign Application Priority Data
Sep. 29, 2020 (EP) 20198892.0

(51) Int. Cl. B42D 25/36; B42D 25/465; B42D 25/351

(52) U.S. Cl. CPC B42D 25/36; B42D 25/465; B42D 25/351

(57) ABSTRACT

A polymer substrate for producing polymer papers of value or polymer security papers is described. The polymer substrate may include a polymer carrier layer, at least one security element applied at least one of onto and into the polymer carrier layer, and a primer. The primer may be applied onto at least one of a first substrate side and a second substrate side of the polymer substrate. The primer may be arranged, at least in some sections, between the polymer carrier layer and the at least one security element. Additionally and/or alternatively, the primer may cover at least one of the at least one security element and the polymer carrier layer such that regions of the at least one security element covered by the primer are not as well visible as regions of the at least one security element and/or the polymer carrier layer not covered by the primer.

### CROSS-REFERENCE TO RELATED APPLICATIONS

This application claims priority to International Patent Application No. PCT/EP2021/076680, filed on Sep. 28, 2021, and European Patent Application No. EP20198892.0, filed on Sep. 29, 2020, the contents of both of which are hereby incorporated by reference in their entirety.

### TECHNICAL FIELD

The disclosure relates to a polymer substrate for producing polymer papers of value or polymer security papers, a polymer paper of value or polymer security paper, as well as a method for producing a polymer substrate.

### BACKGROUND

Polymer papers of value or polymer security papers of the initially mentioned type are usually used to increase protection against forgery of papers of value or security papers, such as banknotes, identification cards, credit cards, debit cards, tickets.

According to the prior art, it is technically impossible to apply a security element with security features in the form of a security thread in polymer papers of value or polymer security papers. In particular, it is impossible, in the case of polymer papers of value and polymer security papers, to introduce a customary and/or conventional security thread directly into the polymer, as it is currently standard in papers of value or security papers made of paper or fibers. Polymer papers of value or polymer security papers based on polymer substrates are currently often used particularly for low denominations. Usually, no expensive security features are applied on these polymer banknotes—for cost reasons, among other factors.

In order to provide a remedy for this shortcoming, security threads in polymer papers of value or polymer security papers are merely imitated by printing measures. Security threads printed on this way, however, cannot economically be produced with a satisfactory quality when compared to the security threads known in the context of papers of value or security papers made of paper or fibers, and they cannot ensure a sufficiently high protection against forgery for a user.

### OVERVIEW

The object of the present disclosure was to overcome the shortcomings of the prior art and to provide a polymer substrate and a method for producing a polymer substrate by means of which polymer papers of value or polymer security papers can be produced with one or multiple highly forgery-proof security elements and/or security element with security features.

This object is achieved by means of a polymer substrate, a polymer paper of value or polymer security paper, and/or a production method according to the claim(s).

The polymer substrate according to the disclosure for producing polymer papers of value or polymer security papers comprises a polymer carrier layer and at least one security element. In this regard, it is provided that the security element is applied onto and/or into the polymer carrier layer and that a primer is applied, at least in sections, onto a first substrate side and/or a second substrate side of the polymer substrate. In this regard, the primer is arranged, at least in sections, between the polymer carrier layer and the security element and/or covers the security element and/or the polymer carrier layer at least in sections, wherein regions of the security element covered by the primer are less visible than regions of the security element not covered by the primer and/or than regions of the polymer carrier layer not covered by the primer.

The polymer substrate according to the disclosure creates the possibility and/or base for producing polymer papers of value or polymer security papers with one or multiple highly forgery-proof security elements and/or security elements with one or multiple security features. With the polymer substrate according to the disclosure, a banknote manufacturer is provided with a base material, which can be further processed generally like or similar to paper for paper banknotes. Thus, a banknote manufacturer may, for example, produce both paper banknotes and polymer banknotes using the same machines and/or process steps, or also by making minor modifications. This entails advantages with respect to an economy of the entire production chain while simultaneously, a high product quality can be achieved.

At this point, it should be noted that within the context of the disclosure, the term security element may mean a variety of security elements known to the person skilled in the art. For example, security elements may be formed as security threads, security strips and the like, wherein, of course, other advantageous types of security elements known to the person skilled in the art are conceivable. In this regard, a security element may have one or multiple identical or different security traits and/or security features. Hence, security features may be optically variable features, features which are optically discernible in transmission or upon reflection, machine-readable features, substances and/or features absorbing or re-emitting electromagnetic waves. For example, security features may be formed as holograms, embossed layers, partially metallized layers, fluorescent layers, printed layers, and/or magnetic encodings and/or optically variable features, in particular as holograms and/or as color-shifting coatings, for example as coatings having a color-shifting thin-layer element. Security features may, in this regard, be arranged in or on security elements and/or be integrated into one, which thus function practically as carriers for the security feature(s). When a security element is mentioned in the following description, this may therefore mean a security element with a separately formed security feature. Generally, it is, of course, also conceivable that the security element is formed with only one security feature. The primer may describe both a separate layer and a composite or a layering made up of multiple layers. This may mean, in this regard, for example multiple identical, but also multiple different, plies or layers.

By means of the security element(s) formed in or on the polymer substrate, an additional degree of protection against forgery is ensured, as a visibility of the security element(s) is decreased as a result of the applied primer. Those regions on the first and/or on the second substrate side, on or in which a security element covered with a primer is formed, can, according to the disclosure, be perceived less well and/or less clearly than those regions of the polymer carrier layer with and/or without a primer on top of it. The primer, which serves to cover the security element(s), but which also may allow a later individual printing of the polymer substrate by the banknote manufacturer, is applied, according to the disclosure, onto the security element(s) and/or onto the polymer carrier layer at least in sections, so that at least selected regions are covered and are not visible or at least less and/or less clearly visible or visible in a less strongly contrasted manner. This effect, that regions covered by the primer are not as well visible as regions not covered by the primer, becomes apparent and/or perceivable for an observer especially when they observe that substrate side of the polymer substrate onto which the primer is applied. Of course, the polymer substrate may also have a primer on both sides. In these embodiments, the effect of the decreased visibility of covered regions would be apparent on both substrate sides. It is also possible that the security element(s) are arranged on or in both outer surfaces of the polymer carrier layer. The at least one security element has the advantage that thereby, the entire portfolio of security elements known according to the prior art, which is also employed for conventional papers for producing paper banknotes, can be applied. Advantageously, it is possible that an observer recognizes the security element covered by the primer only once they observe the polymer substrate in transmitted light.

Once the security element(s) are applied into the polymer carrier layer, it may be advantageous if the polymer carrier layer is formed to be thinner at those points in which the security element(s) are to be applied. Hence, it is possible that a visibility of the security element is additionally reduced, or, respectively, that the point, at which the security element is arranged, is hidden or “masked” because no or barely perceptible elevations are present. Here, the primer may possibly contribute to a “masking” of the points having security elements.

An advancement, according to which it is provided that the regions of the security element covered by the primer are not visible from a top view and are visible when looking through, or that the regions of the security element covered by the primer are better visible when looking through than from a top view, is also advantageous. This advantageous embodiment may make it easier for a user to verify the authenticity of a polymer banknote by holding it against a light or looking through it. Hence, a further contribution to the protection against forgery in polymer banknotes can be made. Here, it is also possible that, when looking through, not the entire region of the security element covered by the primer is visible but only parts thereof. This is true, for example, when the security element is formed with a thread or a thread film with a partial metallization. In that case, merely the partial metallization of the thread film is perceptible in transmitted light. In case of a partial metallization, the metal layer may contain—just to name a few examples—cutouts in the form of signs, letters, patterns, motives, geometric figures, guilloches, and also lines.

According to an advantageous advancement, it is possible that the security element and/or the polymer carrier layer and/or the primer are covered by a cover layer at least in some sections, wherein regions of the security element covered by the cover layer are not as well visible as regions of the security element not covered by the cover layer and/or as regions of the polymer carrier layer not covered by the cover layer and/or as regions of the primer not covered by the cover layer. This advancement may be advantageous especially in those embodiments in which the primer is arranged, at least in some sections, between the polymer carrier layer and the security element. This way, optical effects can be obtained and, in particular, a visibility contrast between regions with a cover layer and regions without a cover layer can be caused by means of printing over selected regions—for example also in the course of printing banknotes.

Furthermore, it may be provided that the primer is applied by means of a printing method. Thereby, a uniform and even primer and/or primer layer can be realized in an economical manner. This may be advantageous particularly for further processing the polymer substrate in the course of subsequent banknote printing and may contribute to a high product quality. Apart from printing methods, it would of course also be conceivable and possibly advantageous if the primer is applied by means of lacquering, dip coating, spray coating, or roller coating. Applying the primer by means of vacuum-based coating methods, such as plasma coating or PVD and CVD coating, is also conceivable.

In addition to this, it may be provided that the primer is designed to be printable. A good printability may be of importance in further processing of the polymer substrate when printing banknotes and may at times make a satisfactory or also high final quality of a polymer paper of value or polymer security paper possible. Additionally, a good printability of the primer or the polymer substrate may have a positive effect on the durability and/or resilience of a polymer banknote. For example, a good printability may be realized by means of an even primer, or also by means of a structure taking on the printing ink well, or the material of the primer.

An embodiment, according to which it may be provided that the primer covers the polymer carrier layer and/or the security element across the entire surface, is also advantageous. It may, at times, be favorable for reasons of protection against forgery of polymer banknotes if the security element(s) are completely covered and thus, are only barely and/or not clearly visibly from a top view.

According to an advancement, it is possible that the primer partially covers the polymer carrier layer and/or the security element. Such regions of the security element(s), which are not covered by the primer and are thus visible from a top view, are customarily referred to as windows. Security element configured like this in the form of a thread are often referred to as window thread. Such windows may be formed as so-called half windows or also as full windows. Half windows are cutouts in the primer on only one substrate side of the polymer substrate and/or on one side of the primer. If the primer is applied on both substrate sides of the polymer substrate and if cutouts are provided to be opposite one another or at least partially opposite and/or overlapping in the two-sided primer, the technical jargon refers to a full window. These windows may make it easier for a user to verify the authenticity of a polymer banknote easily and quickly. Additionally, the partial covering of one or multiple security features may improve a protection against forgery since an imitation and/or forgery of polymer banknotes is made considerably more difficult by an exact positioning of windows.

Additionally, it may be provided that the primer is formed to be diffusely scattering, in particular that the primer creates a white color impression in daylight. This embodiment may have a positive effect particularly on a polymer banknote manufacturable from the polymer substrate, since a white primer layer and/or surface may allow for a particularly high-quality subsequent printing or other application of motives, numbers, and the like. Such layers and/or primers are also known as “opacifying layers” in the English language. The ink used in this is also referred to as opaque ink.

Furthermore, it may be provided that the polymer carrier layer is made from plastic, in particular a translucent plastic, wherein the polymer carrier layer preferably comprises at least one of the materials from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone, (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinylchloride (PVC) ethylene tetrafluoroethylene (ETFE), polytetrafluoroethylene (PTFE), polyvinyl fluoride (PVF), polyvinylidene fluoride (PVDF), and ethylene-tetrafluoroethylene-hexafluoropropylene-fluoropolymer (EFEP) and/or mixtures and/or copolymers and/or composite materials of these materials or is made of at least one of these materials.

According to a particular embodiment, it is possible that the primer has a thickness of between 1 μm and 50 μm, preferably between 5 μm and 30 μm, particularly preferably between 7 μm and 25 μm, in particular between 10 μm and 20 μm. A low thickness of the primer may be advantageous insofar as it may contribute to a thin polymer substrate. End products such as polymer banknotes should have a low thickness, so that they are easily printable and also easily stackable in a space-saving manner. For this purpose, an advantageous base can be created by forming a thin yet covering primer. Additionally, the polymer substrate may advantageously be between 30 μm and 150 μm, preferably between 35 μm and 110 μm, particularly preferably between 50 μm and 100 μm, in particular between 65 μm and 90 μm. If the security element(s) are formed to comprise a transfer film, which transfer film also comprises a detachable carrier film in addition to the security feature(s), this carrier film may have a thickness of between 6 μm and 100 μm, preferably 8 μm and 50 μm, particularly preferably 10 μm and 36 μm, in particular 12 μm and 23 μm. The transferred security element, that is that part of the security element that had the detachable carrier film removed after being applied onto the polymer substrate, may have a thickness of 1 μm to 50 μm, preferably a thickness of 1 μm to 40 μm, particularly preferably between 2 μm and 30 μm, in particular between 5 μm and 20 μm.

According to an advantageous advancement, it may be provided that the security element is formed having at least one security feature by means of optically variable features, features which are optically discernible in transmission or upon reflection, machine-readable features and/or by means of substances and/or features absorbing or re-emitting electromagnetic waves. In this regard, this may be an embossed layer, a partially metallized layer, a fluorescent layer, a printed layer, a magnetic encoding and/or an optically variable feature, in particular a hologram and/or a color-shifting base layer, for example a base layer having at least one color-shifting thin-layer element. This embodiment has the advantage that a user can select from a large portfolio and a plurality of possible combinations of security features. Thereby, a high degree of protection against forgery can be realized.

The disclosure also relates to a method for producing a polymer substrate with at least one security element for producing polymer papers of value or polymer security papers, in particular for producing the polymer substrate according to one of claims 1 to 11.

In this, the following method steps are provided:
providing a polymer carrier layer,
providing at least one security element,
applying the security element onto and/or into the polymer carrier layer,
optionally connecting the security element to the polymer carrier layer,
applying a primer at least in some sections to a first substrate side and/or a second substrate side of the polymer substrate, which primer is applied, at least in some sections, between the polymer carrier layer and the security element and/or by means of which primer the security element and/or the polymer carrier layer is covered at least in some sections, wherein the regions of the security element covered by the primer are not as well visible as the regions of the security element not covered by the primer and/or as the regions of the polymer carrier layer not covered by the primer.

The method for producing a polymer substrate according to the disclosure creates the possibility of and/or base for producing polymer papers of value or polymer security papers with one or multiple highly forgery-proof security elements. With the polymer substrate produced according to the disclosure, a banknote manufacturer is provided with a product, which can generally be further processed in methods like or similar to the production of paper banknotes. Thus, a banknote manufacturer may, for example, produce both paper banknotes and polymer banknotes using the same machines and/or process steps, or also by making minor modifications. A polymer substrate produced according to the disclosure entails advantages with respect to an economy of the entire production chain while simultaneously, a high product quality can be achieved.

In the course of the method, one or multiple security elements are applied onto the polymer carrier material, wherein a security element comprises at least one security feature. Optionally, a method step casing a, preferably permanent, connection between the security element and the polymer carrier material may take place. This connection may be effected, for example, by means of suitable adhesives on the security element and/or on the polymer carrier material. Of course, it is also conceivable and possible that the connection is facilitated and/or accelerated by heat influence or pressure. The connection may additionally be made easier or be facilitated by a possibly desired embedding of the security element(s) into the polymer carrier layer. Embedding means, in particular, that the security element(s) is introduced into the polymer carrier layer. In this regard, cutouts may generally be provided in the polymer carrier layer, in which cutouts the security element(s) are embedded. Alternatively, it is also conceivable that the security element(s) are embedded into the polymer carrier layer by the material of the polymer carrier layer being displaced or also compressed. Preferably, the security elements may be introduced into the polymer carrier layer so deeply that a continuous, that is smooth or approximately smooth surface of the substrate sides is formed, or that the security elements do not lift off the polymer carrier layer and thus, do not increase the thickness of the polymer carrier layer.

By means of the security element(s) formed in or on the polymer substrate, an additional degree of protection against forgery is ensured, as a visibility of the security element(s) is decreased as a result of the applied primer. Those regions on the first and/or on the second substrate side, on or in which a security element covered with a primer is formed, can, according to the disclosure, be perceived less well and/or less clearly than those regions of the polymer carrier layer with and/or without a primer on top of it. The primer, which serves to cover the security element(s), but which also may allow a later individual printing of the polymer substrate by the banknote manufacturer, is applied, according to the disclosure, onto the security element(s) and/or onto the polymer carrier layer at least in sections, so that selected regions are covered and are not visible or at least less and/or less clearly visible or visible in a less strongly contrasted manner. It is also possible that the security element(s) are arranged on or in both outer surfaces of the polymer carrier layer. The at least one security element has the advantage that thereby, the entire portfolio of security elements known according to the prior art, which is also employed for conventional papers for producing paper banknotes, can be applied.

Furthermore, it may be provided that the security element is formed by a transfer film comprising at least one security feature and a detachable carrier film, wherein the detachable carrier film is removed after the application or after the optional connection. By means of this advantageous embodiment, it is made possible to apply the at least one security element easily and precisely onto the polymer substrate. Additionally, this embodiment allows realizing a number of possible combinations and designs.

By means of this advantageous embodiment, it is made possible to apply the at least one security element easily and precisely onto the polymer substrate. Additionally, this embodiment allows realizing a number of possible combinations and designs. Additionally, this advancement has the advantage that that part of the security element which remains on the polymer substrate without the carrier film may be formed to be particularly thin. This is due to the fact that security elements with detachable transfer film with very thin security features can be realized.

Furthermore, it may be provided that the primer is applied by means of a printing method. Thereby, a uniform and even primer and/or primer layer can be produced in an economical manner. This may be advantageous particularly for further processing the polymer substrate in the course of subsequent banknote printing and may contribute to a high product quality. Apart from printing methods, it would of course also be conceivable and possibly advantageous if the primer is applied by means of lacquering, dip coating, spray coating, or roller coating. Applying the primer by means of vacuum-based coating methods, such as plasma coating or PVD and CVD coating, is also conceivable.

An embodiment, according to which it may be provided that the polymer substrate is cut, in particular cut into sheets, prior to the application of the security element and/or prior to the application of the primer, is advantageous. This method step may entail advantages due to the process. For example, security elements on cut sheets can possibly be applied in an easier or also more precise manner. It is also possible that, due to the process, it is more economical if, in the case of low quantities, the polymer substrate is cut prior to the application of the security element(s) and/or prior to the application of the primer. Additionally, an application of the security elements and/or an application of the primer may possibly take place more easily on small-format sheets as these are, at times, easier to handle. This may be useful particularly if an application of the security elements and/or an application of the primer is to take place on both substrate sides.

According to an advancement, it is possible that the security element is applied directly onto and/or into the polymer carrier layer, or that the security element is applied in register onto the polymer carrier layer. A direct application of one or multiple security elements may be useful particularly if the primer is to be applied afterwards over the entire surface. An application in register, that is while realizing a register set-up, may be advantageous and/or increase the quality if it is provided that the security element(s) are not to be covered completely by the primer, that is that so-called windows are realized. In this regard, it may be advantageous with respect to a high product quality if the planned and/or predefined windows are not covered by the primer or only within narrow tolerance limits.

According to the disclosure, a polymer paper of value or polymer security paper with at least one security element comprising a polymer substrate is also provided. In this regard, the polymer substrate is formed according to one of claims 1 to 11 and/or the polymer substrate is produced in a method according to one of claims 12 to 16.

Additionally, an advancement is advantageous, according to which it is provided that a primer is applied, at least in some sections, onto a first substrate side and/or a second substrate side of the polymer substrate, which primer is arranged between a polymer carrier layer and the security element, wherein the security element and/or the polymer carrier layer are covered by a cover layer at least in some sections, wherein regions of the security element covered by the cover layer are less well visible than regions of the security element not covered by the cover layer and/or as regions of the polymer carrier layer not covered by the cover layer and/or as regions of the primer not covered by the cover layer.

For the purpose of better understanding of the disclosure, it will be elucidated in more detail by means of the figures below.

### BRIEF DESCRIPTION OF THE DRAWINGS

These show in a respectively very simplified schematic representation:

FIG. 1 shows a cross-section of a first embodiment of a polymer substrate with three fully covered security features;

FIG. 2 shows a cross-section of a second embodiment of a polymer substrate with two partially covered security features;

FIG. 3 shows a cross-section of a third embodiment of a polymer substrate with three fully covered security features;

FIG. 4 shows a cross-section of a fourth embodiment of a polymer substrate with two partially covered and one fully covered security feature;

FIG. 5 shows a cross-section of a fifth embodiment of a polymer substrate with security features applied on both sides;

FIG. 6 shows a cross-section of a sixth embodiment of a polymer substrate;

FIG. 7 shows a top view of a seventh embodiment of a polymer substrate;

FIGS. 7a to 7d each show a cross-section of the seventh embodiment according to FIG. 7.

### DETAILED DESCRIPTION

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

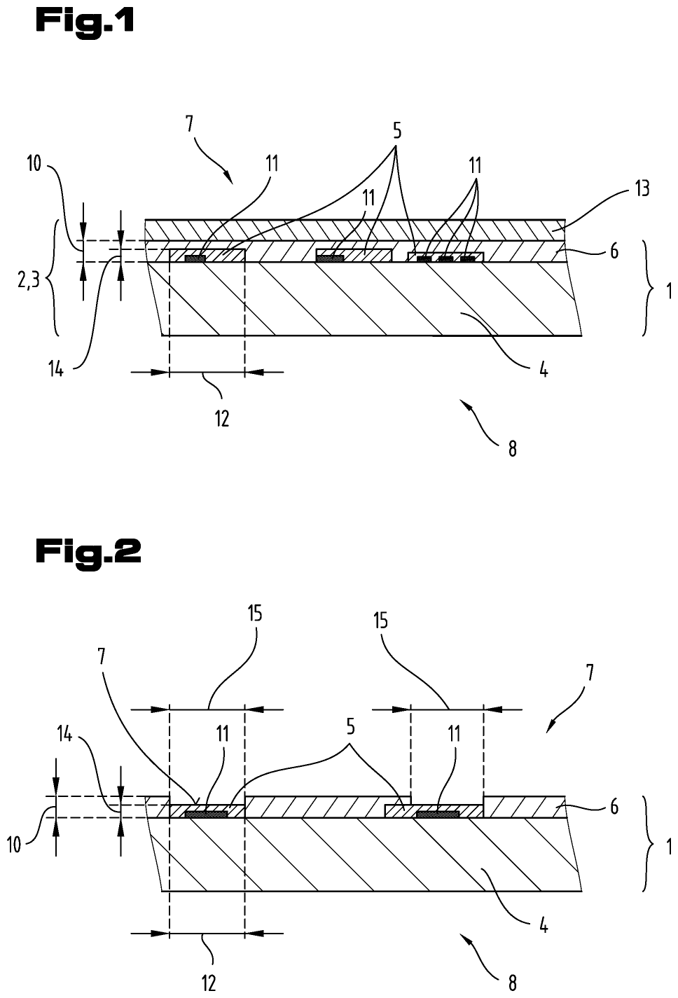

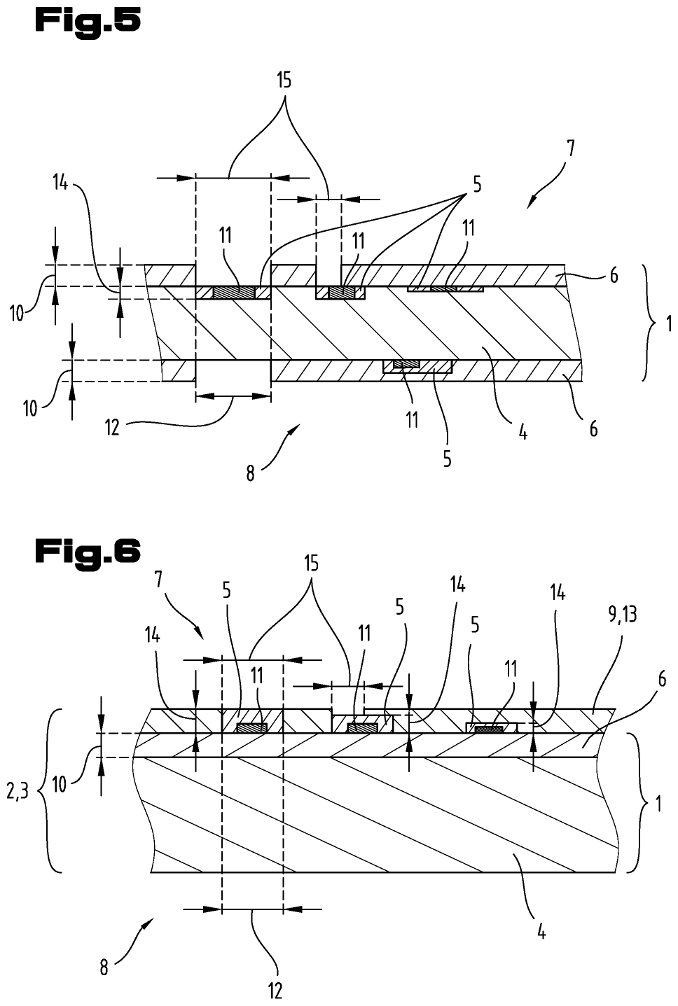

FIG. 1 shows a first embodiment of a polymer substrate 1 in the cross-section with three fully covered security elements 5 and/or security features 11, which are formed in a security element 5. This first embodiment also shows a polymer paper of value 2 or a polymer security paper 3, which was made from the polymer substrate 1. For example, a banknote printing layer 13 was applied, as shown, onto a substrate side 7, 8 and/or onto a primer 6. This further processing step may take place, particularly, in a banknote or value paper print shop. The banknote printing layer 13 may be formed for pictographically representing images, numbers, and the like, but may also have and/or comprise further security features 11 or further security elements 5. It is also possible that the banknote printing layer 13, as sketched in FIG. 6, is formed as a cover layer 9. This may be advantageous, particularly when the primer 6 is arranged between the polymer carrier layer 4 and the security feature 11 and/or the security element 5.

FIGS. 1 to 7 show possibly independent embodiments of the polymer substrate 1 and/or of the polymer substrate 1 produced according to the production method described in the claims, wherein equal reference numbers and/or component designations are used for equal parts as in the preceding FIG. 1. Subsequently, the embodiments according to FIGS. 1 to 7 are described jointly in order to avoid repetitions.

FIGS. 1 to 7 show, by way of example, seven conceivable embodiments of polymer substrates 1. FIGS. 1 to 6 additionally also show exemplary embodiments of polymer papers of value 2 or polymer security papers 3. It should be explicitly pointed out that a plurality of further embodiment variants is conceivable, and the embodiments shown are only to be interpreted as examples. If, in the following, security elements 5 are mentioned, security elements 5 having one or also multiple identical or different security features 11 are referred to. For the sake of readability, however, most times only security elements 5 will be mentioned.

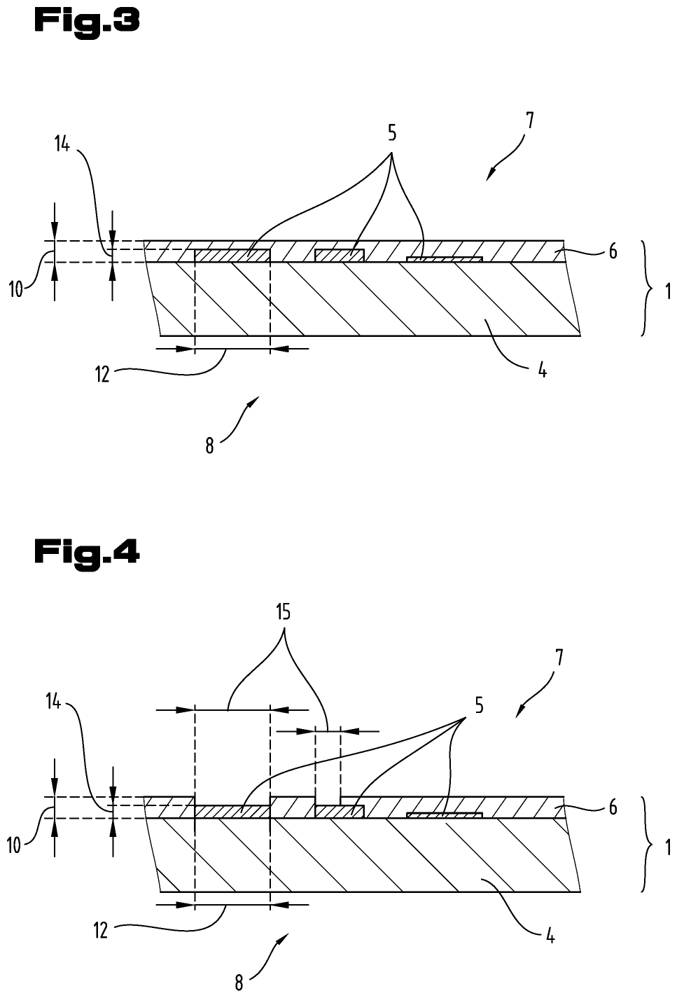

FIGS. 1 to 7 show differently formed polymer substrates 1 comprising a polymer carrier layer 4 and at least one security element 5. Specifically, FIG. 1 shows three security elements 5 of the same width 12 but with different heights 14. FIG. 2 shows a polymer substrate 1 with two security elements 5 of different widths 12. In FIGS. 3 and 4, three security elements 5 of different widths 12 and heights 14 are illustrated. The security elements 5 and also security features 11 are, in this regard, shown with a rectangular cross-section in all figures. However, it is of course also possible that security elements 5 and also security features 11 may have different geometries. FIGS. 1 to 5 additionally show that the security element(s) 5 are applied onto (FIGS. 1, 2, 3, 4 and 6) and/or into (FIG. 5) the polymer carrier layer 4. An application of security features 11 into the polymer carrier layer 4 may take place in cutouts intended for this purpose in the polymer carrier layer 4 and/or may take place with the application of pressure and/or temperature. It is also conceivable that the polymer carrier layer 4 has a lower thickness at those points at which security elements 5 are to be applied, so that the security element 5 can be accommodated therein completely or approximately completely. This way, as even a final polymer substrate 1 as possible can be realized. Generally, alternative embodiments are also conceivable, but not pictured, in which security elements 5 are formed both in and on the polymer carrier layer 4. Furthermore, it is possible and possibly useful of security elements 5 are applied not only on one side of the polymer carrier layer 4, as shown in FIGS. 1 to 4, but also on both sides of the polymer carrier layer 4, as it is shown by FIG. 5. In FIGS. 1 to 4, it is shown that a primer 6 is applied onto a first substrate side 7 of the polymer substrate 1 at least in some sections. If security elements 5 are applied on both sides of the polymer carrier layer 4, it may also be useful if the primer 6 is applied onto the first substrate side 7 and additionally on a second substrate side 8. This may take place, for example, on the basis of FIG. 5. FIG. 6 shows that it is also conceivable that the primer 6 is applied between the polymer carrier layer 4 and the security elements 5. The three security elements 5 shown are arranged on the primer 6 in this example. However, it could also be that the security elements 5 are at least partially embedded into the primer 6.

In FIGS. 1 to 5, the primer 6 covers at least the security elements 5 at least in some sections, wherein the regions of the security elements 5 covered by the primer 6 are not as well visible as the regions of the security element 5 not covered by the primer 6 and/or as the regions of the polymer carrier layer 4 not covered by the primer 6. Preferably, the regions of the security elements 5 covered by the primer 6 may not be as well visible in a top view as the regions of the polymer carrier layer not covered by the primer 6. In FIGS. 1 and 3, the security elements 5 are completely covered by the primer 6 and can thus not be seen by a user observing the polymer substrate 1 from a top view or are less visible and/or perceptible compared to uncovered regions. In FIG. 2, the security elements 5 are each covered only in part and/or partially by the primer 6. These non-covered regions or sections are perceived as so-called windows 15 by an observer looking at them from above. As these windows 15 are only on one side of the polymer substrate 1, they are also referred to as half windows. FIG. 4 shows a security element 5 without an overlying primer 6, as well as a partially covered security element 5 and a fully covered security element 5. In this regard, the non-covered and the partially covered security element 5 are each identifiable and/or observable by means of half windows. FIG. 5 shows that the primer 6 may also be applied on the second substrate side 8 at least in some sections, that is partially. If the regions not covered by the primer 6 are opposite one another, the windows 15 formed thereby are referred to as full windows. FIG. 5 thus shows—as described from left to right—a full window, a half window, and a fully covered security element 5. In FIG. 6, the primer 6 is applied over the full surface of the first substrate side 7, wherein the three security elements 5 are arranged on the primer 6. A cover layer 9, which may be a banknote printing layer 13, is applied partially onto the first substrate side 7. In this regard, the cover layer 9 may cover the security elements 5 completely or partially and thus form windows. As shown, however, it is also conceivable that the cover layer 9 does not cover the security elements 5.

It is also possible that one or also multiple security elements 5 comprising a transfer film are formed. The transfer film may have the security feature(s) 11 and a detachable carrier film, wherein the transfer film is limited at its outer side by the detachable carrier film. Here, it is possible that the detachable carrier film is removed in the course of producing the polymer substrate 1, after the application or after the optional connection of the security feature 11 and/or the security element 5 to the polymer carrier film 4.

The regions of the security element 5 covered by the primer 6 may not be visible or only barely visible from a top view and visible when looking through. Alternatively, the regions of the security element 5 covered by the primer 6 may show better visibility when looking through than from a top view. For example, a user may hold the polymer substrate 1 against the light and thus optically perceive and/or see the sections of the security elements 5 covered by the primer 6.

Additionally, it may be useful if the primer 6 is applied by means of a printing method. Additionally, the primer 6 may be formed to be printable. The primer 6 may additionally be formed to be diffusely scattering. In particular, it is possible that the primer 6 creates a white color impression for a user in natural or also artificial light incidence. The primer 6 may have a thickness 10 of between 1 μm and 50 μm, preferably between 5 μm and 30 μm, particularly preferably between 7 μm and 25 μm, in particular between 10 μm and 20 μm.

The polymer carrier layer 4 may be made from plastic, in particular a translucent plastic. The polymer carrier layer 4 may preferably comprise at least one of the materials from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone, (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyimide (PA), polycarbonate (PC), cycloolefin copolymers (COC), polyoxymethylene (POM), acrylonitrile-butadiene-styrene (ABS), polyvinylchloride (PVC) ethylene tetrafluoroethylene (ETFE), polytetrafluoroethylene (PTFE), polyvinyl fluoride (PVF), polyvinylidene fluoride (PVDF), and ethylene-tetrafluoroethylene-hexafluoropropylene-fluoropolymer (EFEP) and/or mixtures and/or copolymers and/or composite materials of these materials or can be made of at least one of these materials.

The security element(s) 5 may be formed having at least one security element 11, which may be formed, for example, by means of optically variable features, features which are optically discernible in transmission or upon reflection, machine-readable features and/or by means of substances and/or features absorbing or re-emitting electromagnetic waves.

During the production of the polymer substrates 1 according to FIGS. 1 to 5, it may be useful if the polymer substrate 1 is cut, in particular cut into sheets, prior to the application of the at least one security element 5 and/or prior to the application of the primer 6. Furthermore, the security element 5 may be applied directly onto and/or into the polymer carrier layer 4, or be applied in register onto the polymer carrier layer 4. The application in register and/or while carrying out a register set-up may be useful particularly if the primer 6 is applied partially and thus, windows 15 are formed. Here, it is important if the primer 6 covers the intended windows 15 due to a register set-up that is not dimensionally accurate.

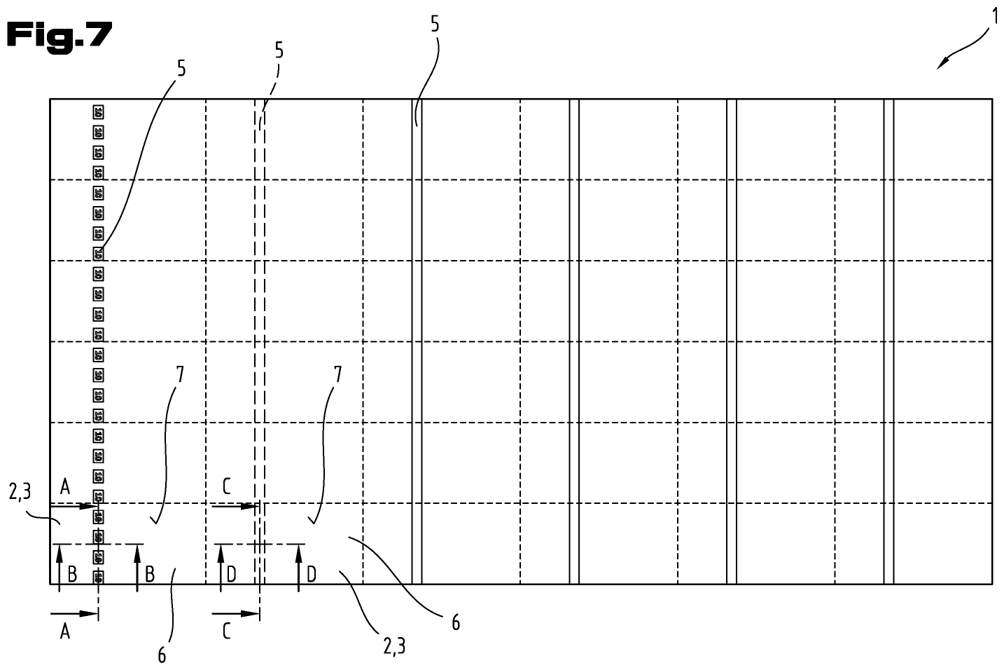

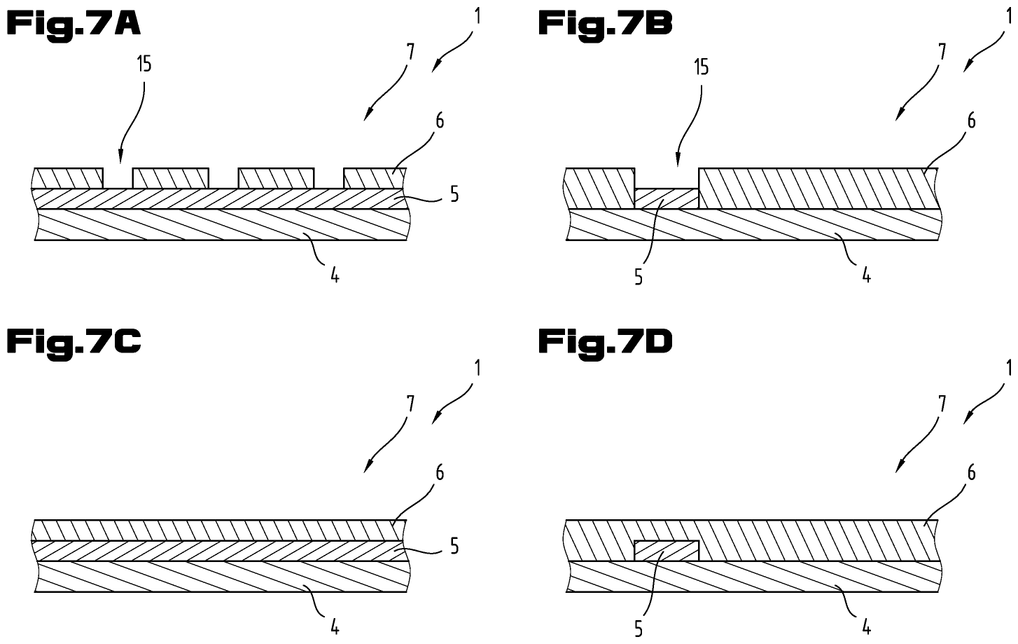

FIG. 7 shows an embodiment of a polymer substrate 1 and/or a sheet of a polymer substrate 1 in a top view. In this regard, the polymer substrate 1 is divided into zones by means of finely dashed lines, which zones mark the regions for polymer papers of value 2 and/or polymer security papers 3 that can be tailored from the polymer substrate 1 and/or from the processed polymer substrate 1. The column on the far left of FIG. 7 comprises—merely by way of example—six of such zones. In this regard, this left column is formed with a security element 5 embodied as a security thread, wherein the security element 5 is covered in some sections with a primer 6. In a top view onto the polymer substrate 1, an observer can identify the regions covered by the primer 6 better than the regions of the security element 5 not covered by the primer.

The second column from the left shown in FIG. 7 also comprises six of such zones. In this regard, this second column from the left is formed with a security element 5 embodied as a security thread, wherein, however, the security element 5 is covered completely with a primer 6. In this regard, the regions of the security element 5 covered by the primer 6 may not be visible from a top view and visible when looking through it, and/or the regions of the security element 5 covered by the primer 6 may be better visible when looking through than from a top view. The effectively masking effect is shown in the second column from the left by means of roughly dashed lines, wherein these lines adumbrate that the security element 5 formed as a thread is arranged below.

FIGS. 7a to 7d each show sectional views of the embodiment according to FIG. 7 in a cross-section. The sectioning positions of the respective cross-sections according to FIGS. 7a to 7d are sketched in FIG. 7 and indicated by means of corresponding letters and position arrows. FIGS. 7a to 7c each show sections through the length of the security element 5 and/or the security thread. FIGS. 7b and 7d show sections across the security element 5 and/or the thread.

The exemplary embodiments show possible embodiment variants, and it should be noted in this respect that the disclosure is not restricted to these particular illustrated embodiment variants of it, but that rather also various combinations of the individual embodiment variants are possible and that this possibility of variation owing to the technical teaching provided by the present disclosure lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 Polymer substrate
2 Polymer paper of value
3 Polymer security papers
4 Polymer carrier layer
Security element
6 Primer
7 Substrate side
8 Substrate side
9 Cover layer
Thickness
11 Security feature
12 Width
13 Banknote printing layer
14 Height
15 Window

1. A polymer substrate for producing polymer papers of value or polymer security papers, the polymer substrate comprising:
a polymer carrier layer;
at least one security element applied at least one of onto and into the polymer carrier layer; and
a primer applied onto at least one of a first substrate side of the polymer substrate and a second substrate side of the polymer substrate at least in some sections
wherein at least one of:
the primer is arranged, at least in some sections, between the polymer carrier layer and the at least one security element; and
the primer covers at least one of the at least one security element and the polymer carrier layer at least in some sections, wherein regions of the at least one security element covered by the primer are not as well visible as at least one of (i) regions of the at least one security element not covered by the primer and (ii) regions of the polymer carrier layer not covered by the primer.

2. The polymer substrate according to claim 1, wherein the regions of the at least one security element covered by the primer are at least one of:
not visible from a top view and are visible when looking through; and
better visible when looking through than from a top view.

3. The polymer substrate according to claim 1, further comprising a cover layer, wherein:
at least one of the at least one security element, the polymer carrier layer, and the primer are covered by the cover layer at least in some sections; and
regions of the at least one security element covered by the cover layer are not as well visible as at least one of (i) regions of the at least one security element not covered by the cover layer, (ii) regions of the polymer carrier layer not covered by the cover layer, and (iii) regions of the primer not covered by the cover layer.

4. The polymer substrate according to claim 1, wherein the primer is applied via a printing method.

5. The polymer substrate according to claim 1, wherein the primer is printable.

6. The polymer substrate according to claim 1, wherein the primer fully covers at least one of a surface of the polymer carrier layer and a surface of the at least one security element.

7. The polymer substrate according to claim 1, wherein the primer partially covers at least one of the polymer carrier layer and the at least one security element.

8. The polymer substrate according to claim 1, wherein the primer is diffusely scattering.

9. The polymer substrate according to claim 1, wherein:
the polymer carrier layer is composed of plastic; and
the polymer carrier layer comprises at least one of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethylene imide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinylchloride (PVC) ethylene tetrafluoroethylene (ETFE), polytetrafluoroethylene (PTFE), polyvinyl fluoride (PVF), polyvinylidene fluoride (PVDF), ethylene-tetrafluoroethylene-hexafluoropropylene-fluoropolymer (EFEP), and mixtures, copolymers and composite materials thereof.

10. The polymer substrate according to claim 1, wherein the primer has a thickness of 1 μm to 50 μm.

11. The polymer substrate according to claim 1, wherein:
the at least one security element includes at least one security feature; and
the at least one security feature includes at least one of:
an optically variable feature;
a feature that is optically discernible at least one of in transmission and upon reflection;
a machine-readable features;
a feature readable via a substance; and
a feature that at least one of absorbs and re-emits electromagnetic waves.

12. A method for producing a polymer substrate for producing polymer papers of value or polymer security papers, comprising:
providing a polymer carrier layer;
providing at least one security element;
applying the at least one security element at least one of onto and into the polymer carrier layer; and
applying, at least in some sections, a primer onto at least one of a first substrate side of the polymer substrate and a second substrate side of the polymer substrate;
wherein at least one:
the primer is applied, at least in some sections, between the polymer carrier layer and the at least one security element; and
the primer covers at least one of the at least one security element and the polymer carrier layer at least in some sections, wherein regions of the at least one security element covered by the primer are not as well visible as at least one of (i) regions of the at least one security element not covered by the primer and (ii) regions of the polymer carrier layer not covered by the primer.

13. The method according to claim 12, wherein the at least one security element is formed by a transfer film including at least one security feature and a detachable carrier film, and wherein the detachable carrier film is removed after the application of the at least one security element.

14. The method according to claim 12, wherein the primer is applied via a printing process.

15. The method according to claim 12, further comprising cutting the polymer substrate, prior to at least one of the application of the at least one security element and the application of the primer.

16. The method according to claim 12, wherein the security element is applied at least one of:
directly onto the polymer carrier layer;
directly into the polymer carrier layer; and
in register onto the polymer carrier layer.

17. A polymer paper of value or a polymer security paper, comprising the polymer substrate according to claim 1.

18. The polymer paper of value or the polymer security paper according to claim 17, further comprising a cover layer, wherein:
at least one of the at least one security element, the polymer carrier layer, and the primer are covered by the cover layer at least in some sections; and
regions of the at least one security element covered by the cover layer are less well visible than at least one of (i) regions of the at least one security element not covered by the cover layer, (ii) regions of the polymer carrier layer not covered by the cover layer, and (iii) regions of the primer not covered by the cover layer.

19. The polymer substrate according to claim 1, wherein the polymer carrier layer is composed of a translucent plastic.

20. A polymer substrate for producing polymer papers of value or polymer security papers, the polymer substrate comprising:
a polymer carrier layer;
a security element applied to the polymer carrier layer; and
a primer applied onto at least one of a first substrate side of the polymer substrate and a second substrate side of the polymer substrate;
wherein the primer is arranged between the polymer carrier layer the security element.
